(19) United States
(12) Patent Application Publication
(10) Pub. No.: US 2006/0278718 A1
(43) Pub. Date: Dec. 14, 2006

(54) Illuminated identification patch

(76) Inventors: Robert Lee Senter, Castle Rock, CO (US); Robert Edward Matuszewski, Castle Rock, CO (US)

Correspondence Address: SETTER ROCHE LLP, P.O. BOX 780, ERIE, CO, 80516, US

(21) Appl. No.: 11/151,080

(22) Filed: Jun. 13, 2005

(51) Int. Cl. G06K 19/06

(52) U.S. Cl. 235/491

(57) ABSTRACT

An identification patch is provided which includes an illumination system in optical communication with a light transmission medium configured to interact with light from the illumination system to enhance the visibility of the light. Coupled with the illumination system and the light transmission medium is a backing configured to be attached to an external item. An opaque layer in optical communication with the light transmission medium is included which comprises a pattern configured to selectively permit transmission of the light from the illumination system external to the patch.

### BACKGROUND OF THE INVENTION

Situations in which a number of people belonging to two or more identifiable groups that are congregated or assembled within a single area often create an identification problem as to which people belong to which group. Examples of such a situation may involve military personnel of two or more factions located on a battlefield, jumping from aircraft, or maneuvering underwater. As is often the case, identification of who is friend or foe is vital for survival under such conditions. For example, such identification may help avoid the occurrence of death or serious injury from friendly fire. Participants under less dire circumstances, such as a police force engaging in crowd control, a party of hunting companions, or a group of friends taking part in a friendly paintball game, may also benefit from easy identification of associates among a larger group. Also, identification of such individuals predominantly hidden in rough terrain or thick vegetation is typically difficult, regardless of the number of people located in the vicinity. Further, darkness, low light situations, or inclement weather conditions can also make detection of associates extremely difficult.

Several identification methods are currently employed under such circumstances. Typically, each member of the same faction wears the same or similar uniform for identification purposes, possibly employing reflective materials. However, similarities in uniforms between factions may make identification difficult nonetheless. Also, many such uniforms are specifically designed to visually blend in with surrounding foliage. Further, darkness or foul weather make detection difficult, no matter the particular uniform used.

To supplement the uniform, flashlights that are either handheld or mounted to headgear, such as a helmet, have been employed. However, flashlights typically are somewhat bulky and heavy, placing a physical burden on the person carrying the flashlight. Reflective clothing is also a recognizable alternative, but at least a modicum of light must fall upon the reflective components for some recognition to occur. Considering the extraordinary amount of equipment and supplies, such as weapons, ammunition, rations, water, and numerous other items military personnel routinely carry, the size, weight, and accessibility of any identification system is of significant concern.

In the alternative, transmitters emitting radio frequency signals may provide another means of identifying an associate. Determining a precise position of the transmitter of the signal is often difficult without the use of triangulation or a similar method for locating the source of the signal. A particularized signal, possible including information regarding the location of the wearer, may be employed, but such capability is often susceptible to jamming transmission, and is typically complex and expensive compared to optically-oriented systems.

### SUMMARY OF THE INVENTION

One embodiment of the present invention provides an identification patch having an illumination system in optical communication with a light transmission medium configured to interact with light from the illumination system to enhance the visibility of the light. Coupled with the illumination system and the light transmission medium is a backing configured to be attached to an external item. Also included is an opaque layer in optical communication with the light transmission medium, wherein the opaque layer comprises a pattern configured to selectively permit transmission of the light from the illumination system external to the patch.

Additional embodiments and advantages of the present invention will be realized by those skilled in the art upon perusal of the following detailed description, taken in conjunction with the accompanying drawings.

### BRIEF DESCRIPTION OF THE DRAWINGS

FIG. 1A is a plan view of the front of an identification patch according to an embodiment of the invention.

FIG. 1B is a plan view of the back of the identification patch of FIG. 1A in a closed configuration.

FIG. 1C is a plan view of the back of the identification patch of FIG. 1A in an open configuration.

FIG. 1D is a simplified plan view of the front of the identification patch of FIG. 1A showing a relative location of an illumination system and a light transmission medium within the patch in outline form according to an embodiment of the invention.

FIG. 2 is a plan view of the illumination system and the light transmission medium shown in outline in FIG. 1D according to an embodiment of the invention.

FIG. 3 is a plan view of the front of an identification patch according to an embodiment of the invention, with the location of an illumination system and the light transmission medium shown in outline form.

FIG. 4A is a side exploded view of an identification patch according to an embodiment of the invention.

FIG. 4B is a side assembled view of the identification patch of FIG. 4A.

FIG. 5 is a block diagram of an illumination system for an identification patch according to an embodiment of the invention.

### DETAILED DESCRIPTION OF THE INVENTION

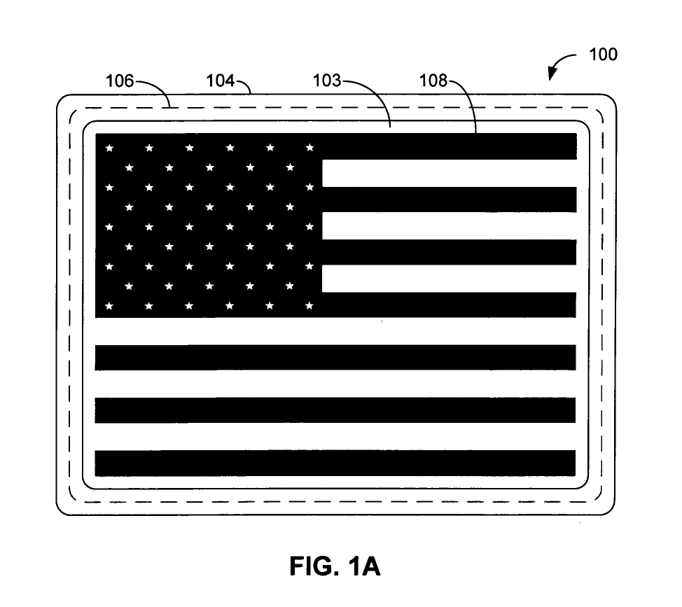

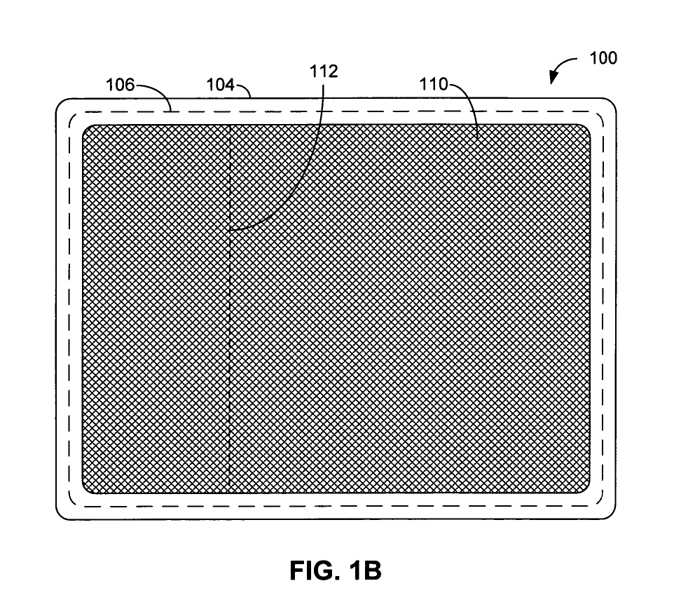

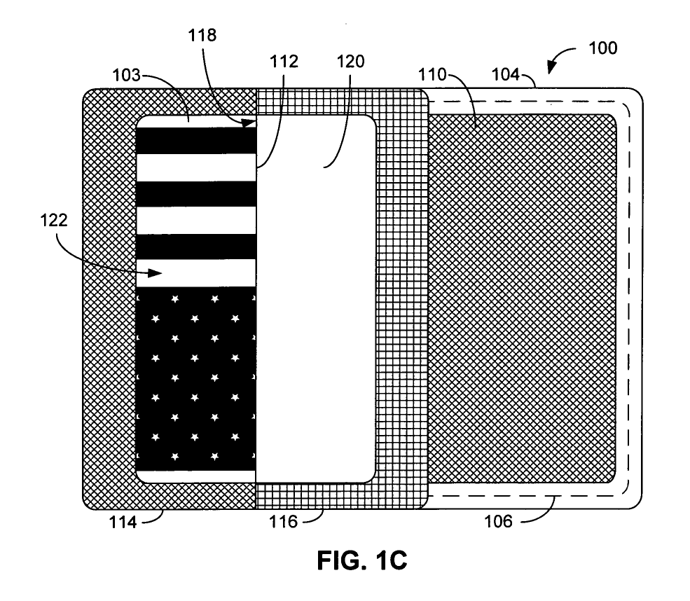

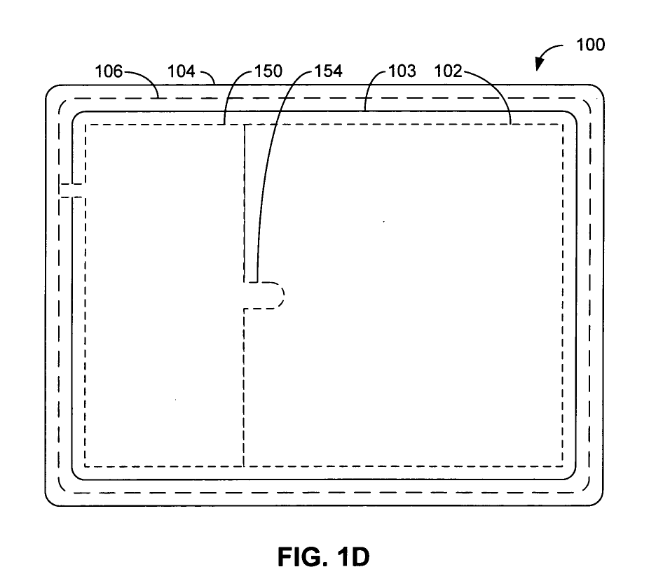

FIGS. 1A-1D depict various views of an identification patch 100 according to an embodiment of the invention.. Generally, the identification patch 100 includes an illumination system 150 optically coupled with a light transmission medium 102, which is configured to interact with light from the illumination system 150 to enhance the visibility of the light. Typically, this enhancement allows others to more readily identify an external item to which the patch 100 is attached. Coupled with the illumination system 150 and the light transmission medium 102 is a backing 1 10 configured to be attached to the external item. Also, an opaque layer 108 is coupled with the illumination system 150 and the light transmission medium 102. The opaque layer 108 defines a pattern configured to selectively permit transmission of the light from the illumination system 150 external to the patch 100.

More specifically, FIG. 1A provides a front plan view of the identification patch 100. The patch 100 includes a substantially translucent layer 103 which extends substantially across the entire front area of the patch 100. Similarly, FIG. 1B is a rear plan view of the patch 100, primarily illustrating the backing 110. In one particular implementation, the substantially translucent layer 103 and the backing 110 are coupled by way of stitching 106 through a binding 104 located about the edges of the substantially translucent layer 103 and the backing 110. Other fastening means for coupling the substantially translucent layer 103 and the backing 110, such as snaps, zippers, and the like, may be employed in alternative embodiments.

In one embodiment, an opaque layer 108 defining a pattern resides atop the substantially translucent layer 103. In the particular example of FIG. 1A, the pattern resembles the United States flag. Any other pattern desired for a particular application, such as an organizational logo, basic geometric shapes, standard alphanumeric characters, and the like, may be employed in the alternative. The opaque layer 108 thus selectively permits transmission of light external to the patch 100 to provide a specific lighted configuration readily observed by others for identification purposes. In addition, the pattern of the opaque layer 108 is readily visible when light is not emitted from the illumination system 150, thus providing an additional measure of identification under those conditions. In one implementation, the opaque layer 108 is comprised of ink or paint that has been screen-printed or painted onto the surface of the substantially translucent layer 103 according to the desired pattern. In alternative embodiments, the opaque layer 108 may be printed on the side of the substantially translucent layer 103 facing the backing 110 to reduce the possibility of the opaque layer 108 becoming damaged or worn through use. In another implementation, the opaque layer 108 may be reflective to enhance its visibility.

FIG. 1B presents a plan view of the back of the patch 100, which primarily shows the backing 110, which is configured to be attached to an article of apparel or other external item. The backing 110 thus allows the patch 100 to be attached as a unit to a piece of clothing (such as a shirt, a pair of pants, a jumpsuit, a coat, and so on), headgear (such as a helmet, cap, and the like), or any other item worn by an individual. In alternative embodiments, the patch 100 may be coupled with other external items not wearable by a person, such as weaponry, equipment, and so on. In one particular example, the backing 110 includes a “hooked” fabric, such as the hooked fabric portion of VELCRO®, which is configured to mate with a “looped” fabric to facilitate quick and simple attachment and removal of the patch 100 from another item. Other types of fasteners, such as snaps, may be employed in alternative embodiments.

FIG. 1B also indicates the location of a possible fold 112, indicated by a vertical dashed line in the figure, to allow access to an interior volume 118 provided by the combination of the substantially translucent layer 103 and the backing 110. While FIG. 1B displays the patch 100 in a closed position, FIG. 1C shows the backing 110 folded substantially along the fold 112 to allow access to the interior volume 118. The back of the substantially translucent layer 103 can be seen in that particular view as a result. Also, the backing 110 may include a reflective layer 120 or coating that reflects any light received from the illumination system 150 back toward the substantially translucent layer 103 to further enhance the visibility of the light in a particular embodiment.

By folding back the backing 110 along the fold 112, an orifice 122 is formed by which the interior volume 118 may be accessed. To maintain the orifice 122 in a closed position, one embodiment employs a hooked fabric portion 114 coupled to the back of the light transmission medium 102, and a looped fabric portion 116 coupled to the interior-facing side of the backing 110. As mentioned above, VELCRO® provides in one example those two types of fabric, which removably attach to each other to form a barrier between the interior volume 118 and the exterior of the patch 100. As mentioned above, other methods of the fastening, such as by way of snaps, hooks, zipper, and the like, may instead by utilized to close the orifice 122. In another embodiment, the orifice 122 and the remainder of the patch 100 may be hermetically sealed, possibly allowing the patch 100 to be employed for diver identification in the event of murky water, extreme depth, or other environmental conditions typically encountered underwater.

In an operating configuration, the illumination system 150 and the light transmission medium 102 reside within the interior volume 118, and are held securely therewithin by the hooked fabric portion 114 and the looped fabric portion 116 surrounding the orifice 122. Thus, the orifice 122 allows access to the illumination system 150 and the light transmission medium 102 for repair or replacement thereof. FIG. 1D provides a simplified front plan view of the patch 100, showing in outline the illumination system 150 and the light transmission medium 102 for the particular embodiment of the patch 100.

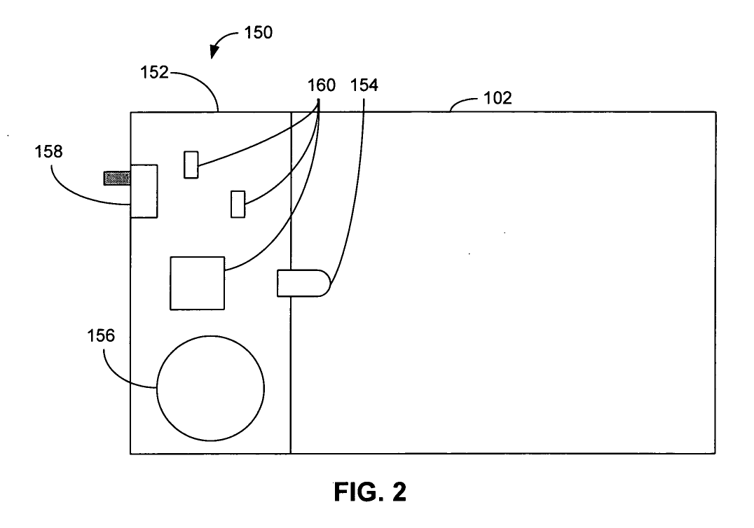

Another view of a specific example of the light transmission medium 102, shown in conjunction with a more detailed illustration of the illumination system 150, is presented in FIG. 2. The light transmission medium 102 may be any material that operates to transmit, reflect, refract, amplify, disperse, radiate, or otherwise enhance the visibility of light directed toward the light transmission medium 102 from the illumination system 150. Depending on the embodiment, the light transmission medium 102 may be a translucent polymer lens, a thermoplastic polymer lens, a reflective translucent lens, or the like. For example, the thermoplastic polymer lens may be extruded from adhesive thermoplastic opaque pellets, and/or pellets with reflective optical attributes. In addition, examples of the light transmission medium 102 may vary in color, reflectivity, translucence, and other attributes. Also, more than one light transmission medium 102, and possibly more than one type thereof, may be used in other embodiments to provide variety in the visual effect produced by the patch 100.

Continuing with the illumination system 150 of FIG. 2, a printed circuit board (PCB) 152 provides both the mechanical substrate and the electrical connections for several components utilized for generating light for the illumination system 150. More specifically, a light source, such as a light-emitting diode (LED) 154 is coupled to a power source, such as a battery 156, by way of a switch 158. The battery 156 may be coupled to the PCB 152 by way of a removable retainer or other means to allow replacement of the battery 156. In one embodiment, the LED 154 may be an infrared LED, thus making the illumination system 150 an infrared illumination system. Other electronic components 160, such as resistors, capacitors, integrated circuits (ICs) and the like, may also be resident on the PCB 152. The particular embodiment of FIG. 2 employs a three-position switch 158 that allows the illumination system 150 to operate in at least three separate modes: light source 154 on, light source 154 off, and light source 154 on according to a timing sequence, such as a regular flashing period. More details concerning the illumination system 150 are provided below.

Given the physical configuration of the illumination system 150 and the light transmission medium 102, FIG. 1D indicates that the light source 154 is coupled into the end of the light transmission medium 102. In one embodiment, the illumination system 150 and the light transmission medium 102 may be snapped or otherwise connected together to provide a singular structure. In this embodiment, light from the illumination system 102 extends from one end of the light transmission medium 102 to another to enhance visibility of the light across the length of the patch 100 to observers.

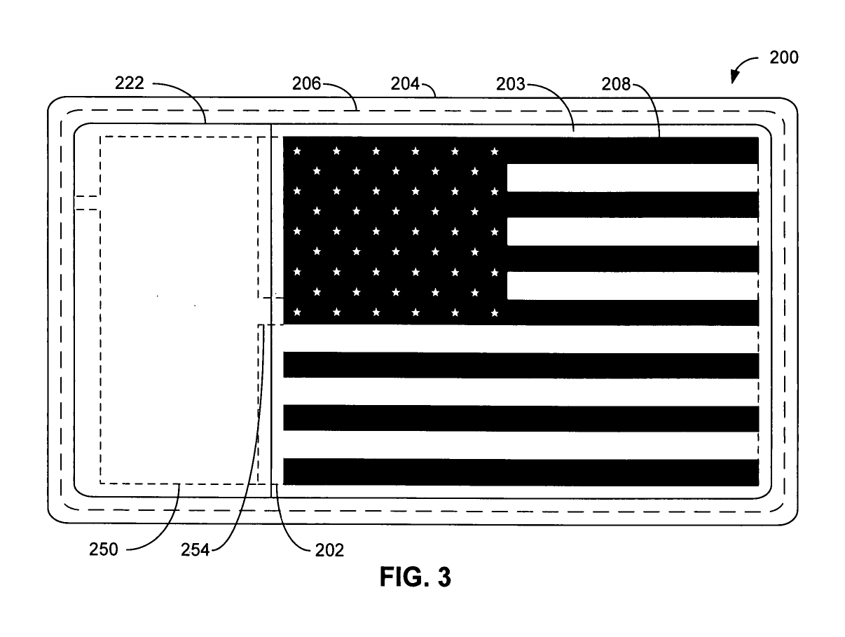

In a separate embodiment of an identification patch 200, a front plan view of which is presented in FIG. 3, a different position for an illumination system 250 and a light transmission medium 202 is provided. More specifically, a substantially translucent layer 203, with an opaque layer 208, is coupled with a backing (not shown) by way of a binding 204 and stitching 206, in a fashion similar to that of the identification patch 100 of FIGS. 1A-1D. However, an extension 222 sharing the same side of the patch 200 with the substantially translucent layer 203 is employed in the embodiment of the patch 200. As a result, the majority of the illumination system 250 resides underneath the extension 222, as shown in FIG. 3. In that case, the entirety of the light transmission medium 202 is situated underneath the substantially translucent layer 203. Such a configuration may further enhance the visibility of the light to an observer.

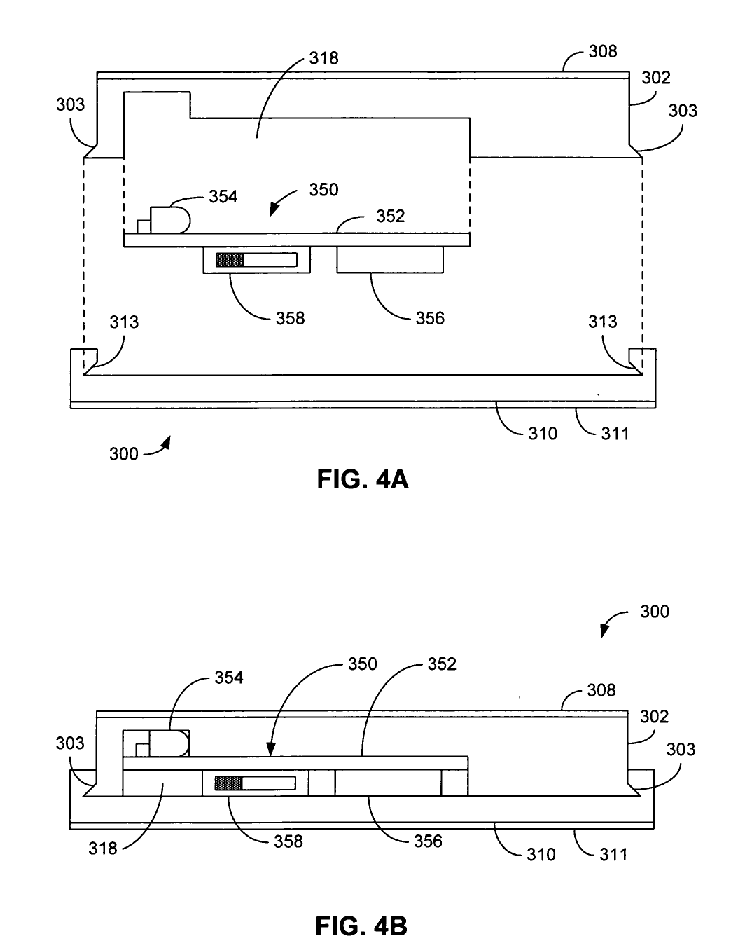

FIG. 4A provides an exploded side view of an identification patch 300 according to another embodiment of the invention. In this example, a light transmission medium 302 is shaped to define an interior volume 318 for an illumination system 350, which incorporates a printed circuit board 352, a light source 354 (such as an LED), a source 356 (such as a battery), and a switch 358 for selectively coupling the light source 356 with the power source 356. Other components (not shown) may also be included for more advanced functionality, as is described in greater detail below. Again, the light source 354 is positioned near one end of the light transmission medium 302 to promote enhanced visibility of the light generated. Atop the light transmission medium 302 lies a patterned opaque layer 308, as described above.

In addition, a pair of tabs 303 are formed on opposing ends of the light transmission medium 303 to mate with a pair of detents 313 defined by a backing 310. Thus, once the illumination system 350 has been placed inside the interior volume 318 as defined by the light transmission medium 302, the backing 310 may be aligned with the medium 302 and snapped into place to complete the assembly of the patch 300. FIG. 4B illustrates an assembled side view of the patch 300. In one embodiment, the backing 310 is molded rubber, which is coupled with a layer of hooked fabric 311 for attachment to a looped fabric that may be connected to an article of clothing or another item.

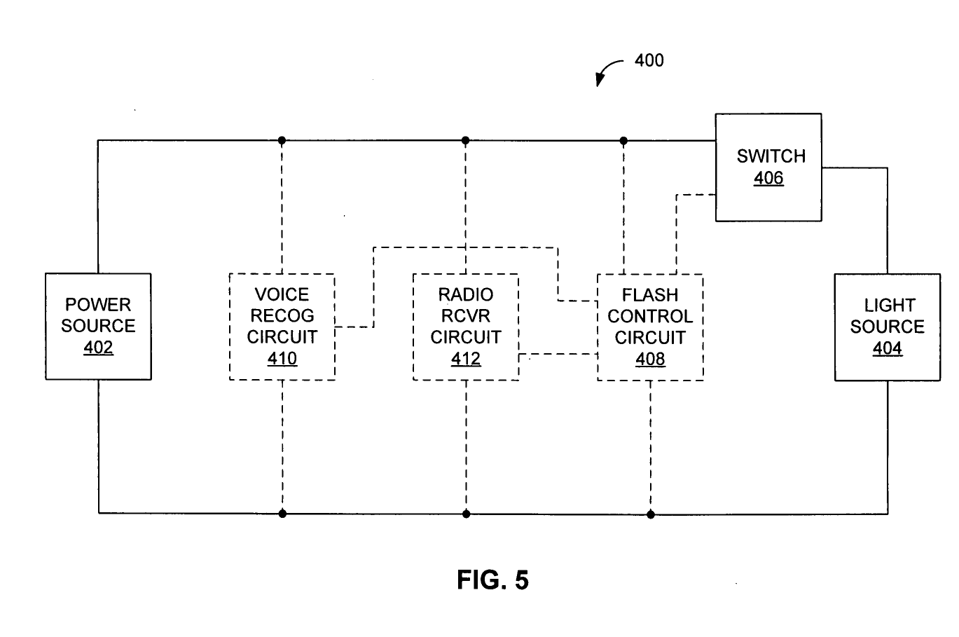

An illumination system 400 according to an embodiment of the invention is portrayed by way of block diagram in FIG. 5. Generally, a power source 402 is operably coupled across a light source 404 to generate light to be coupled with a light transmission medium, such as that discussed above. In one embodiment, the power source 402 is a battery, such as a three-volt CR2016 lithium battery. Other power sources 402 capable of energizing the power source 402 may be used as well.

The light source 404, in a particular example, may be an LED, as mentioned above. In alternative embodiments, multiple LEDs of varying colors may be utilized to generate a multitude of colors for aesthetic or informational purposes. In another example, the light source 404 may be an infrared LED. Such an LED would emit light lying outside the visible spectrum, such as in the wavelength range of 10 microns or longer, thus allowing detection only by an observer utilizing infrared-sensitive equipment while remaining invisible to the naked eye under light or dark conditions. Typically, LEDs of any frequency require one or more resistors (not shown in FIG. 400) for current-limiting purposes to prevent premature failure of the LED while allowing an acceptable light emission level to be generated. In addition, varying duty cycles for energizing the light source 402 may allow control of the light intensity electronically. In alternative embodiments, laser diodes, incandescent lamps, fluorescent light sources, and other sources of light may be employed.

In further reference to FIG. 5, the power source 402 and the light source 404 may be coupled by way of a switch 406. Depending on the requirements of a particular application, the switch 406 may be a mechanical switch, a momentary switch, or the like. In one embodiment, the switch 406 may be operated by a wearer through a backing, a substantially translucent layer, or a light transmission medium by pushing or a similar motion. In another embodiment, a portion of the switch 406 extends through an opening in the patch to allow easy modification of illumination modes by the wearer.

In one particular embodiment, the switch 406 is a three-position switch allowing selection of at least an “off” mode, an “on” mode, and a “timing sequence” mode for the light emission from the light source 402. In that case, the timing sequence may be a simple periodic or intermittent flashing mode. In another implementation, the timing sequence may relate information to a third party according to a code, such as Morse code. To implement basic and more complex timing sequences, a flash control circuit 408 may be included in the illumination system 400, possibly coupled with the switch 406, as shown in FIG. 5, or directly with the light source 404.

In alternative embodiments, a voice recognition circuit 410 may be coupled with the flash control circuit 408 to allow a wearer of the patch to verbally indicate one or more modes for operating the illumination system 400. For example, the wearer may indicate by way of verbal commands, such as “on,” “off,” “flash,” and the like, the desired operating mode of the illumination system 400. Typically, the voice recognition circuit 410 would also include or be coupled with a microphone (not shown in FIG. 5) placed for receipt of the verbal commands by the wearer. In other embodiments, the voice recognition circuit 410 may be coupled directly with the light source 402 or the switch 406.

Alternatively to, or in addition to, the voice recognition circuit 410, a radio receiver circuit 412 may be coupled with the flash control circuit 408 or the switch 406 to receive illumination mode commands over radio frequency signals. This capability would allow remote operation and control of the illumination system by personnel not within physical reach of the-patch. Each patch worn by a large group associated with a faction may be controlled in such a manner, saving possibly valuable time for each wearer.

Each of the flash control circuit 408, the voice recognition circuit 410, and the radio receiver circuit 412 would likely be powered by the same power source 402 configured to drive the light source 404. Also, each of these circuits 408, 410, 412 may be implemented solely in hardware by way of an application-specific integrated circuit (ASIC), discrete electronic components, or some combination thereof. Alternatively, these various control elements may be implemented by way of a microprocessor, microcontroller, or similar algorithmic device executing software configured to perform the functions of the circuit 408, 410, 412.

Generally, embodiments of the present invention provide a small, light, inexpensive apparatus providing a simple, efficient and versatile means for identifying people or objects, especially in situations involving reduced visibility. Several embodiments offering varying levels of functionality and cost have been presented.

While several embodiments of an identification patch have been discussed herein, other embodiments encompassed by the scope of the invention are possible. For example, while some embodiments of the invention as described herein employ specific components, such as batteries and LEDs, other functionally-equivalent components may be utilized in the alternative. Further, aspects of one embodiment may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims.

What is claimed is:

1. An identification patch, comprising:
an illumination system;
a light transmission medium in optical communication with the illumination system, wherein the light transmission medium is configured to interact with light from the illumination system to enhance a visibility of the light from the illumination system;
a backing coupled with the illumination system and the light transmission medium, wherein the backing is configured to be attached to an external item; and
an opaque layer in optical communication with the light transmission medium, the opaque layer comprising a pattern configured to selectively permit transmission of the light from the illumination system external to the patch.

2. The identification patch of claim 1, further comprising a substantially translucent layer connected with the backing;
wherein the substantially translucent layer and the backing define an interior volume within which the illumination system and the light transmission medium reside; and
wherein the opaque layer resides atop a surface of the substantially translucent layer.

3. The identification patch of claim 2, wherein the substantially translucent layer and the backing are stitched together to form the interior volume.

4. The identification patch of claim 2, wherein the substantially translucent layer and the backing further define an orifice through which the illumination system and the light transmission medium may be inserted into the interior volume.

5. The identification patch of claim 4, further comprising a fastener for closing the orifice.

6. The identification patch of claim 5, wherein the fastener comprises a hooked fabric portion and a looped fabric portion.

7. The identification patch of claim 1, wherein the backing comprises rubber.

8. The identification patch of claim 1, wherein the backing comprises a hooked fabric portion configured to be operably coupled with a looped fabric portion of the external item.

9. The identification patch of claim 1, wherein the light transmission medium and the backing are configured to snap together to define an interior volume within which the illumination system resides, and wherein the opaque layer resides atop a surface of the light transmission medium.

10. The identification patch of claim 1, wherein the illumination system is an infrared illumination system.

11. The identification patch of claim 1, wherein the illumination system further comprises:
a light source; and
a power source operably coupled with the light source.

12. The identification patch of claim 11, the light source comprising a light-emitting diode.

13. The identification patch of claim 11, the illumination system further comprising a switch configured to couple the light source with the power source.

14. The identification patch of claim 11, the illumination system further comprising an electrical circuit configured to intermittently energize the light source with the power source according to a timing sequence.

15. The identification patch of claim 14, wherein the timing sequence is programmable.

16. The identification patch of claim 15, wherein the timing sequence comprises a code imparting information to a third party.

17. The identification patch of claim 14, the illumination system further comprising a switch configured to turn the light source on, turn the light source off, and turn the light source on according to the timing sequence.

18. The identification patch of claim 11, the illumination system further comprising a radio receiver circuit configured to operate the light source according to a signal received by the radio receiver circuit.

19. The identification patch of claim 11, the illumination system further comprising a voice recognition circuit configured to operate the light source according to a verbal command.

20. The identification patch of claim 1, the light transmission medium comprising a translucent polymer lens.

21. The identification patch of claim 1, the light transmission medium comprising a thermoplastic polymer lens.

22. The identification patch of claim 1, the light transmission medium comprising a reflective, translucent plastic.

23. The identification patch of claim 1, wherein the pattern of the opaque layer resembles a United States flag.

24. The identification patch of claim 1, wherein the opaque layer is reflective.

25. The identification patch of claim 1, wherein the backing further comprises a reflective layer configured to reflect the light from the illumination system.

26. An identification patch, comprising:
means for generating light;
means for enhancing a visibility of light from the generating means;
means for removably attaching the generating means and the enhancing means to an external item; and
means for selectively allowing transmission of a portion of the light from the generating means external to the patch.
